(19) United States
(12) Patent Application Publication
(10) Pub. No.: US 2022/0187820 A1
(43) Pub. Date: Jun. 16, 2022

(54) PREDICTING FAILURES AND MONITORING AN INDUSTRIAL MACHINE USING A MACHINE LEARNING PROCESS AND REFERENCE INFORMATION

(71) Applicant: RAZOR LABS, Tel Aviv (IL)

(72) Inventors: Michael Zolotov, Holon (IL); Erez Zinman, Haifa (IL); Moshe Cohen, Tushiya (IL)

(73) Assignee: RAZOR LABS, Tel Aviv (IL)

(21) Appl. No.: 17/538,958

(22) Filed: Nov. 30, 2021

Related U.S. Application Data
(60) Provisional application No. 63/125,669, filed on Dec. 15, 2020.

(51) Int. Cl. G05B 23/02; G06N 20/00

(52) U.S. Cl. CPC G05B 23/0283; G06N 20/00

(57) ABSTRACT

A method for monitoring an industrial machine, the method may include selecting a selected reference component for each component out of one or more components of the industrial system; the selecting provides one more selected reference components; wherein each selected reference component is selected out of multiple reference components; wherein for each component the selecting is based on similarities between the component and reference components of the multiple reference components; determining one or more learnt mappings between (i) sensed information related to the one or more components and (ii) predicted failures of the one or more components ; wherein the learning is based, at least in part, on one or more reference mappings between (i) sensed information related to the one or more selected reference components and (ii) predicted failures of the one or more selected reference components; monitoring the one or more components to receive monitoring results; and evaluating the operation of the one or more components based on the monitoring results and the one or more reference mapping.

### BACKGROUND

Industrial systems, especially highly complex industrial systems, may have a vast number of components but a relatively low number of malfunctions per component. Thus—even when an industrial system is monitored for prolonged periods of time—the amount of malfunctions per component is very small.

In addition—many highly complex industrial systems are tailored or otherwise uniquely configured to fit their customers—which also reduces the amount of available data per component.

Furthermore—different components of highly complex industrial systems may dramatically differ from each other and sensed information regarding one component of a highly complex industrial system may be uncorrelated and/or otherwise completely different from sensed information regarding another component of a highly complex industrial system. Even sensed information of the same parameter may dramatically change from one sensor to another—especially the values and patterns of sensed information may be substantially different from one sensors to the other.

Machine learning (see wikipedia.org) is the study of computer algorithms that improve automatically through experience. Machine learning algorithms build a model based on sample data, known as “training data”, in order to make predictions or decisions without being explicitly programmed to do so.

The training data that is available for each highly complex industrial system may be too small and may dramatically decrease the accuracy of the model.

There is a growing need to provide a method for applying an accurate machine learning process for monitoring industrial systems—especially highly complex industrial systems.

### SUMMARY

There may be provided systems, methods and computer readable medium as illustrated in the specification.

### BRIEF DESCRIPTION OF THE DRAWINGS

The embodiments of the disclosure will be understood and appreciated more fully from the following detailed description, taken in conjunction with the drawings in which:

FIG. 1 illustrates an example of a method;

FIG. 2 illustrates an example of components and reference components; and

FIG. 3 illustrates an example of a system.

### DESCRIPTION OF EXAMPLE EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

Any combination of any module or unit listed in any of the figures, any part of the specification and/or any claims may be provided.

The specification and/or drawings may refer to a processor. The processor may be a processing circuitry. The processing circuitry may be implemented as a central processing unit (CPU), and/or one or more other integrated circuits such as application-specific integrated circuits (ASICs), field programmable gate arrays (FPGAs), one or more graphic processing units (GPUs), one or more neural network processors, full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the specification and/or drawings may be provided.

Any reference to “may” should also apply to “may not”.

An industrial system is a system that may include one or more components, as defined in the following paragraph. An industrial system may include a large number of components (for example—more than 10, 50, 100, 500, 1000 and the like). The configuration of an industrial system may be tailored per client—for example by changing the combination of components, any parameter of a component, sensor used to monitor the components and the like. The components of the industrial system may form a single or multiple production line(s) or processing line(s) or assembly line(s) of any manufacturing or processing pipeline.

The term “component” refers to any mechanical and/or electrical, such as but not limited to motors, generators, pumps, pistons, drives, brakes, clutches, Conveyors, belts, chain drives, hoses, gearboxes, couplings, centrifuges, ovens, scrappers, positioners, flotation cells, electrical components such as cables, coils, sensors, switches, proxies, etc., components of non-portable systems such as mills, crushers and more, components of portable systems such as bulldozers, excavators, shovels, and more.

The term “component” refers to any mechanical and/or electrical and/or chemical components, such as but not limited to motors, generators, pumps, pistons, drives, brakes, clutches, belts, hoses, gearboxes, centrifuges, ovens, scrappers, electrical components such as cables, coils, etc., chemical components such as flotation cells, components of non-portable systems such as mills, crushers and more, components of portable systems such as bulldozers, excavators, shovels, and more.

The term information may refers to any type of digital information associated with any components of the machine, and may include
Information of numerical sensors that measure various indices of the machine (such as temperature, momentum, etc.),
Information about any event that has happened in the past (such as alarms, warnings, logs and Saturdays that have happened in the past). The information may include both the time of the event, its duration, description, and any other metadata associated with it.
Any information about how the machine is maintained in the past, and how to handle and repair any downtime is planned and unplanned in the past.
Any information that is output from a computer (controller), such as Computed Variables, alarms, set points, limits, logic steps, throughputs etc.

There may be provided an accurate method for monitoring industrial systems such as highly complex industrial systems.

The method may be applied on a single component of an industrial system or more than a single component of the industrial system.

The one or more components may include some of the components of the industrial system, all of the components of the industrial system, some of the monitored components of the industrial system, or all the monitored components of the industrial system.

A monitored component may be a component of the industrial system having one or more of its parameters being sensed—directly or indirectly.

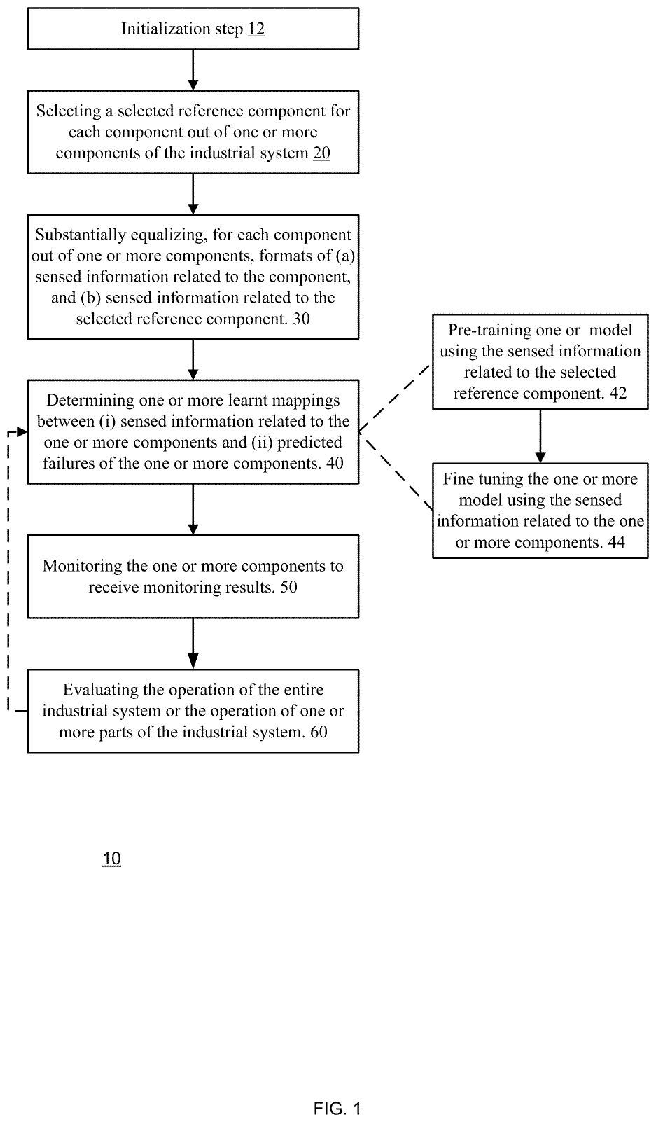

FIG. 1 illustrates method 10 for monitoring an industrial machine.

Method 10 may include by initialization step 12.

Initialization step 12 may include one or more out of:
Determining or receiving a definition of one or more components of the industrial system on which to apply the method.
Obtaining a selection parameter for selecting a selected reference sensor.

The determining of the one or more components may be based, at least in part, on an amount of sensed data related to malfunctions of the one or more components. For example—determining whether the amount of sensed data is enough for building a model.

Initialization step 12 may be followed by step 20 of selecting a selected reference component for each component out of one or more components of the industrial system.

Step 20 may provide one more selected reference components.

Each selected reference component is selected out of multiple reference components.

For each component (of the one or more components) the selecting is based on similarities between the component and reference components of the multiple reference components.

The selected reference sensor is selected out of multiple reference sensors used for monitoring multiple reference components.

The selecting may be based on similarities between the component and reference components of the multiple reference components.

If multiple parameters of a component and multiple parameters of a reference components are measured (for example temperature, torque, pressure, rotational speed, velocity, and the like) then the similarities between (a) the types and/or value range and/or pattern of values of parameters measured for the component and (a) the types and/or value range and/or pattern of values of parameters of the parameters measured for the reference components may also be taken into account. If, for example, a certain reference component is sensed by a reference sensor of a certain type and a component is measured by a sensor of another type—without any overlapping—then the certain reference component may not be selected.

For example—if the component is a high power (For example—more than 10000 Watts) engine then it may be beneficial to find a reference high power engine. If the engine has additional parameters (type of engine, number of phases, and the like)—the selection criteria may take into account one, some or all of the parameters of the engine.

The similarity criteria and the algorithm to be applied for the selecting may be determined and/or provided in any manner

The selected reference sensor may be the best matching (or most similar) reference sensor of the multiple sensors—but other criteria may be used for the selection.

Step 20 may be followed by step 40. Alternatively—step 20 may be followed by step 30 and step 30 may be followed by step 40. Step 30 may be followed by step 30 of increasing the similarity, for each component out of one or more components, between formats of (a) sensed information related to the component, and (b) sensed information related to the selected reference component.

The increasing of the similarity between the formats in a manner should enable step 40 to operate while associating the same types of sensed information components and of selected reference components. For example comparing a temperature reading of a component to a temperature reading of a selected reference component associated with the component.

The term substantial may allow deviations from perfect equalization—the equalization may be related to various parameters.

Step 30 may include, for example, ordering the sensed information related to the component and the sensed information related to the selected reference component at the same manner Step 30 may include filling gaps in the sensed information related to the selected reference component during pretraining a model. The filling may include providing random or low autocorrelated values.

Step 30 may be followed by step 40 of determining one or more learnt mappings between (i) sensed information related to the one or more components and (ii) predicted failures of the one or more components.

At least some of the one or more learnt mappings may be applied one after the other. At least some of the one or more learnt mappings may be associated with different components, and the like. For example, a first learnt mapping and a second learnt mapping (or more that two learnt mappings) may be associated with each component of one or more components of the industrial system.

Step 40 may be based, at least in part, on one or more reference mappings between (i) sensed information related to the one or more selected reference components and (ii) failures of the one or more selected reference components.

It is assumed that there is much more information (for example—more by a factor of 5-1000 and even more failure information) related to the failures of the one or more selected reference components than to failures of the one or more components of the industrial system. Thus—initially, the one or more reference mappings are more reliable than any initial mapping between (i) the sensed information related to the one or more components and (ii) predicted failures of the one or more components.

The one or more mappings may include a first learnt mapping between (i) sensed information related to the one or more components and (ii) the sensed information related to the one or more selected reference components. The first learnt mapping may transform component sensed information to selected reference component sensed information.

A first learnt mapping regarding a component may be learnt by feeding a machine learning process with (a) sensed information related to a proper operation of the component and (b) sensed information related to a proper operation of the selected reference component. In many cases, most (and even virtually all) of the sensed information related to the operation of the component are related to the proper operation of the component.

A proper operation may be free of faults, free of critical faults, free of predefined faults, or any operation that is defined to be proper. The proper operation may fulfill one or more predefined criteria regarding what proper is.

The one or more learnt mappings may include a second learnt mapping between the sensed information related to the one or more selected reference components and the predicted failures of the one or more components.

There may be one or more first learnt mapping and/or one or more second learnt mapping per component of the one or more components.

Step 40 may be executed without machine learning.

Alternatively, step 40 may involve machine learning.

For simplicity of explanation it is assumed that the step 40 includes machine learning.

Step 40 may include building one or more model. A model may be learnt per component of the failures of the one or more components. A model may be learnt per more than a single component. More than a single model may be learnt per a component.

For simplicity of explanation it will be assumed that each component is associated with a first model (represents the first learnt mapping) and a second model (represents the second learnt mapping).

Thus—the one or more components are associated with one or more first models and one or more second models.

The one or more first models may be replaced by a first model that is related to the one or more components. For example—a single first model may be used to model the entire industrial system or may be used to model any portion of the industrial model.

The one or more second models may be replaced by a second model that is related to the one or more components.

Step 40 may include step 42 of pre-training one or model using the sensed information related to the selected reference component.

Step 42 may be followed by step 44 of fine tuning the one or more model using the sensed information related to the one or more components.

The fine tuning may include adjusting the at least one mode in any manner

For example—step 44 may include replacing a last layer of the one or more model.

The replacement of the last layer may be responsive to a number of defect attributes associated with the one or more components. Defect attributes may include the defect type, defect criticality, a time window in which a defect is expected to occur, and the like.

Step 44 may include adding few new layers to the one or more model, following the replacing, and continuing to train the one or more model. The adding of the few new layers may increase the similarity between reference sensed information and sensed information about the component, or help the newly modified model to learn the needed similarities by itself.

Any other layer of the model may be amended.

Step 40 may include multiple learning iterations. The multiple learning iterations may include multiple pre-training iterations and/or multiple fine tuning iterations.

A pre-training iteration related to a model (of the one or more models) of the multiple pre-training iterations may include pre-training to provide a pre-trained model followed by validating the pre-trained model. The multiple pre-training iterations may provide multiple pre-trained models. The multiple pre-training iterations may be followed by selecting a selected pre-trained model (of the multiple pre-trained models) based on the validations. Any pre-trained model selection criteria may be used.

The same may be applied to the fine tuning iterations.

A fine-tuning iteration related to a model (of the one or more models) of the multiple fine-tuning iterations may include fine-tuning to provide a fine-tuned model followed by validating the fine-tuned model. The multiple fine-tuning iterations may provide multiple fine-tuned models. The multiple fine-tuning iterations may be followed by selecting a selected fine-tuned model (of the multiple fine-tuned models) based on the validations. Any fine-tuned model selection criteria may be used.

Step 40 may be followed by step 50 of monitoring the one or more components to receive monitoring results.

Step 50 may be followed by step 60 of evaluating the operation of the one or more components based on the monitoring results and the one or more learnt mappings.

Step 60 may include evaluating the operation of the entire industrial system or the operation of one or more parts of the industrial system.

It should be noted that step 40 may at least partially overlap step 50 and/or step 60. Thus—the learning continue based on the monitoring results.

Method 10 may include multiple iterations of steps 40, 50 and 60.

During each iteration, the one or more mappings may be based on monitoring results obtained during one or more previous iterations.

During one or more of the multiple iterations various constraints may be applied on the adjusting of the one or more models.

For example—a constraint may prevent changing of one or more layers while allowing to change one or more other layers (for example the last layer) of the one or more models.

Yet for another example—a constraint may dictate the allowable learning rate to be applied during an iteration.

For example—at a second iteration of steps 40, 50 and 60, the train the one or more model at a learning rate that is lower than a learning rate that was used before the replacement.

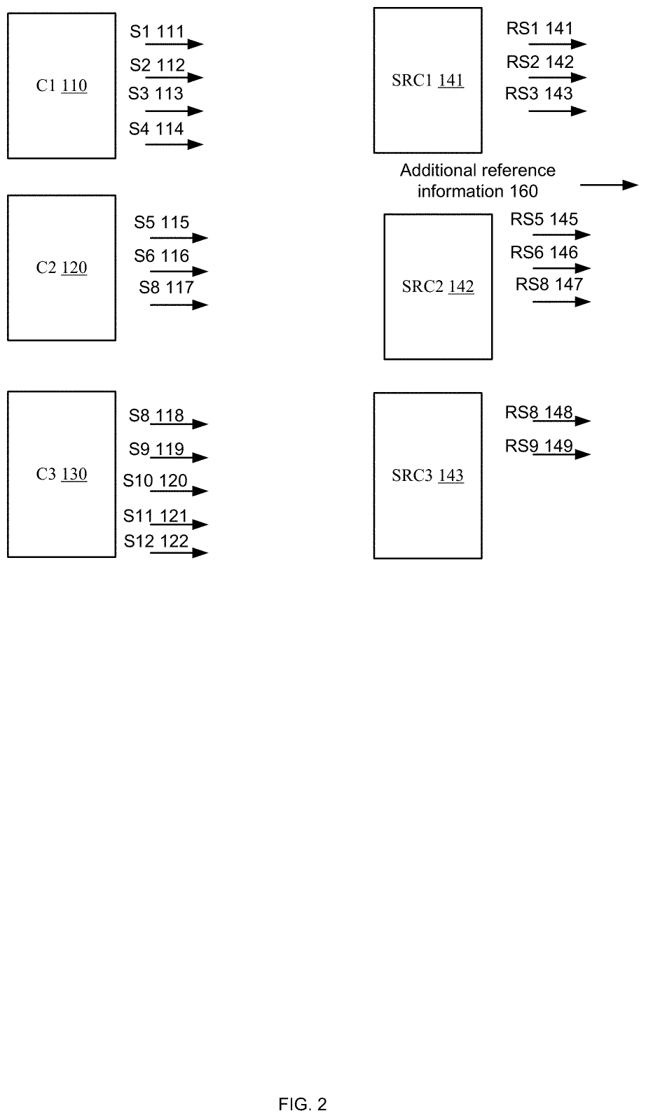

FIG. 2 illustrates an example of an industrial system 100 having three components—first component 110, second component 120 and third component 130.

The first component (C1) 110 is associated with a first sensor (S1) 111, second sensor (S2) 112, third sensor (S3) 113, and fourth sensor (S4) 114.

The second component (C2) 120 is associated with a fifth sensor (S5) 115, sixth sensor (S6) 116, and seventh sensor (S7) 117.

The third component (C3) 130 is associated with an eighth sensor (S8) 118, ninth sensor (S9) 119, tenth sensor (S10) 120, eleventh sensor (S11) 121, and twelfth sensor (S12) 122.

C1 110 is associated with first selected reference component (SR1) 151 that is associated with first reference sensor (RS1) 141, second reference sensor (RS2) 142, and third reference sensor (RS3) 143.

C2 120 is associated with second selected reference component (SRC2) 152 that is associated with fifth reference sensor (RS5) 145, sixth reference sensor (RS6) 146, and seventh reference sensor (RS7) 147.

C3 130 is associated with second selected reference component (SRC3) 153 that is associated with eighth reference sensor (RS8) 148, and ninth reference sensor (RS9) 149.

During a pre-training of a first model related to C1 110—the first model may be trained using (i) sensed information from 51, S2, S3 and S4 regarding to proper behavior of C1 110, (ii) reference sensed information from RS1, RS2, and RS3 regarding the proper behavior of SEC1 151.

The first model related to C1 110 may be trained in order to translate the different sensed information without attempting to predict failures.

During a pre-training of a second model related to C1 110—the second model may be trained using (i) sensed information from S 1, S2, S3 and S4 and (ii) reference sensed information from RS1, RS2, and RS3.

The training of the second model may also use failure information regarding to RS1, RS2 and RS3 and attempting to train the second model to predict failures.

At least the pretraining of the second model may include providing additional reference information such as random numbers to compensate for a lack of reference sensed information from any fourth reference sensor.

The same is applicable, mutatis mutandis to the pre-training of a model related to C2 120 and/or to the pre-training of a model related to C3 130.

During the fine tuning—a first model and a second model related to C1 may be fine-tuned using sensed information from S1, S2, S3 and S4, a first model and a second model related to C2 is fine-tuned using sensed information from S5, S6 and S7, and a first model and a second model related to C3 is fine-tuned using sensed information from S8, S9, S10, S1l and S12.

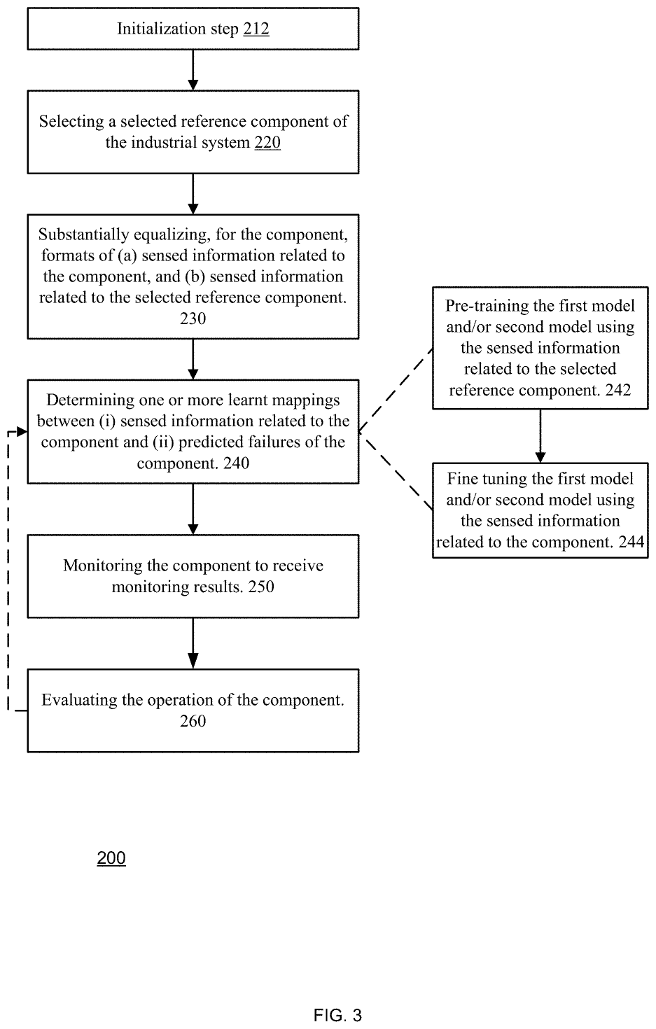

FIG. 3 illustrates method 200 related to a first model and a second model of a component.

It is assumed that the component is selected during initialization step 212.

Initialization step 212 may be followed by step 220 of selecting a selected reference component for the component.

Step 220 may be followed by step 230 of substantially equalizing, a format of (a) sensed information related to the component, and (b) sensed information related to the selected reference component.

Step 230 may be followed by step 240 of determining one or more learnt mappings between (i) sensed information related to the component and (ii) predicted failures of the component.

Step 240 may be based, at least in part, one or more reference mappings between (i) sensed information related to the selected reference component and (ii) failures of the selected reference component.

The one or more learnt mappings may include a first learnt mapping between (i) sensed information related to the component and (ii) the sensed information related to the selected reference component. The first learnt mapping may transform component sensed information to selected reference component sensed information.

A first learnt mapping may be learnt by feeding a machine learning process with (a) sensed information related to a proper operation of the component and (b) sensed information related to a proper operation of the selected reference component.

The one or more learnt mappings may include a second learnt mapping between the sensed information related to the selected reference component and the predicted failures of the component.

Additionally or alternatively, step 40 may include steps 45, 46 and 47.

Step 45 may include receiving reference sensed information related to one or more reference components. Some of the reference sensed information is reference failure sensed information—reference sensed information that was sensed during one or more failures of the one or more reference components.

Step 46 may include the converting the reference sensed information to virtual sensed information. The virtual sensed information may reflect what should have been sensed by one or more sensors of the component when monitoring the component. The virtual sensed information may include virtual failure information that may reflect sensed information that is expected to be sensed by one or more sensors of the one or more component.

Step 47 may include estimating the failures of the component based on sensed information of the component.

Step 47 may include pre-training using the virtual sensed information. Step 47 may also include performing fine tuning (after the completion of the pre-training)—and this may be based on sensed information regarding the component.

For example—assuming that the component is a 1000 watts motor and that there are three reference motors (of 200, 300 and 500 watts) and of the same type of the component.

Step 45 may include receiving reference sensed information related to the three reference motors. The reference sensed information may include reference failure information.

Step 46 may include converting the reference sensed information (of the three reference motors) to virtual sensed information that may represent sensed information of a sensor of the 1000 watts motor. For example—assuming that the reference sensed information of the 200 watts motor should be converted (for example multiplied by five), the reference sensed information of the 300 watts motor should converted (for example multiplied by three and one third), and the reference sensed information of the 500 watts motor should converted (for example multiplied by two) to provide the virtual sensed information. Any other mapping may be applied to generate the virtual sensed information.

Step 47 may include estimating the failures of the component based (at least during the pre-training) on the virtual sensed information and/or based (during the fine tuning) on the sensed information of the component.

Step 240 may include building the first model and the second model. The first learnt mapping may be done by building the first model. The second learnt mapping may be done by building the second model.

Step 240 may include step 242 of pre-training the first model and/or second model using the sensed information related to the selected reference component.

Step 242 may be followed by step 244 of fine tuning the first and/or second model one or more model using the sensed information related to the component.

Step 240 may include multiple learning iterations. The multiple learning iterations may include multiple pre-training iterations and/or multiple fine tuning iterations.

A pre-training iteration may be related to the first model and/or the second model.

The same may be applied to the fine tuning iterations.

A fine-tuning iteration may be related to the first model and/or the second model.

Step 240 may be followed by step 250 of monitoring the component to receive monitoring results.

Step 250 may be followed by step 260 of evaluating the operation of the component based on the monitoring results and the one or more learnt mappings.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “one or more ” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “one or more ” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Rather the scope of the embodiments of the disclosure is defined by the appended claims and equivalents thereof.

What is claimed is:

1. A method for monitoring an industrial machine, the method comprises:
selecting a selected reference component for each component out of one or more components of the industrial system; the selecting provides one more selected reference components; wherein each selected reference component is selected out of multiple reference components; wherein for each component the selecting is based on similarities between the component and reference components of the multiple reference components;
determining one or more learnt mappings between (i) sensed information related to the one or more components and (ii) predicted failures of the one or more components; wherein the learning is based, at least in part, on one or more reference mappings between (i) sensed information related to the one or more selected reference components and (ii) predicted failures of the one or more selected reference components;
monitoring the one or more components to receive monitoring results; and
evaluating the operation of the one or more components based on the monitoring results and the one or more reference mapping.

2. The method according to claim 1 wherein the determining of the one or more learnt mappings is executed without machine learning.

3. The method according to claim 1 wherein the determining of the one or more learnt mappings comprises performing machine learning.

4. The method according to claim 1 wherein the determining of the one or more learnt mappings comprises building one or more model.

5. The method according to claim 1 wherein the determining of the one or more learnt mappings comprises pre-training a machine learning process using the sensed information related to the selected reference component.

6. The method according to claim 1 wherein the determining of the one or more learnt mappings comprises:
pretraining one or more model using the sensed information related to the one more selected reference components; and
fine tuning the one or more model using the sensed information related to the one or more components.

7. The method according to claim 4 wherein the fine tuning comprises replacing a last layer of the one or more model, the replacement is responsive to a number of defect attributes associated with the one or more components.

8. The method according to claim 5 comprising continuing, following the replacing, to train the one or more model while allowing changes in the weights of the last layer of the one or more model; and preventing changes in the weights of other layers of the one or more model.

9. The method according to claim 5 comprising continuing, following the replacing, to train the one or more model at a learning rate that is lower than a learning rate that was used before the replacement.

10. The method according to claim 5 comprising adding few new layers to the one or more model, following the replacing, and continuing to train the one or more model.

11. The method according to claim 1 comprising obtaining a selection parameter for selecting the selected reference component.

12. The method according to claim 1 comprising selecting the one or more components based, at least in part, on an amount of failure information about the one or more components.

13. A non-transitory computer readable medium for monitoring an industrial machine, the non-transitory computer readable medium that stores instructions for:
selecting a selected reference component for each component out of one or more components of the industrial system; the selecting provides one more selected reference components; wherein each selected reference component is selected out of multiple reference components; wherein for each component the selecting is based on similarities between the component and reference components of the multiple reference components;
determining one or more learnt mappings between (i) sensed information related to the one or more components and (ii) predicted failures of the one or more components; wherein the learning is based, at least in part, on one or more reference mappings between (i) sensed information related to the one or more selected reference components and (ii) predicted failures of the one or more selected reference components;
monitoring the one or more components to receive monitoring results; and
evaluating the operation of the one or more components based on the monitoring results and the one or more reference mapping.

14. The non-transitory computer readable medium according to claim 13 wherein the determining of the one or more learnt mappings is executed without machine learning.

15. The non-transitory computer readable medium according to claim 13 wherein the determining of the one or more learnt mappings comprises performing machine learning.

16. The non-transitory computer readable medium according to claim 13 wherein the determining of the one or more learnt mappings comprises building one or more model.

17. The non-transitory computer readable medium according to claim 13 wherein the determining of the one or more learnt mappings comprises pre-training a machine learning process using the sensed information related to the selected reference component.

18. The non-transitory computer readable medium according to claim 13 wherein the determining of the one or more learnt mappings comprises:
pretraining one or more model using the sensed information related to the one more selected reference components; and
fine tuning the one or more model using the sensed information related to the one or more components.

19. The non-transitory computer readable medium according to claim 18 wherein the fine tuning comprises replacing a last layer of the one or more model, the replacement is responsive to a number of defect attributes associated with the one or more components.

20. The non-transitory computer readable medium according to claim 19 that stores instructions for continuing, following the replacing, to train the one or more model while allowing changes in the weights of the last layer of the one or more model; and preventing changes in the weights of other layers of the one or more model.

21. The non-transitory computer readable medium according to claim 19 that stores instructions for continuing, following the replacing, to train the one or more model at a learning rate that is lower than a learning rate that was used before the replacement.

22. The non-transitory computer readable medium according to claim 19 that stores instructions for adding few new layers to the one or more model, following the replacing, and continuing to train the one or more model.

23. The non-transitory computer readable medium according to claim 13 that stores instructions for obtaining a selection parameter for selecting the selected reference component.

24. The non-transitory computer readable medium according to claim 13 that stores instructions for selecting the one or more components based, at least in part, on an amount of failure information about the one or more components.
